(19) United States
(12) Patent Application Publication
(10) Pub. No.: US 2025/0253449 A1
(43) Pub. Date: Aug. 7, 2025

(54) ENCLOSURE FOR BATTERY CELL INCLUDING NANOPRECIPITATION STRENGTHENED STEEL

(71) Applicant: GM GLOBAL TECHNOLOGY OPERATIONS LLC, Detroit, MI (US)

(72) Inventors: Diptak BHATTACHARYA, Royal Oak, MI (US); Zhou WANG, Shanghai (CN); Jianfeng WANG, Shanghai (CN); James R. SALVADOR, East Lansing, MI (US); Ryan Patrick HICKEY, Austin, TX (US)

(21) Appl. No.: 18/598,139

(22) Filed: Mar. 7, 2024

(30) Foreign Application Priority Data
Feb. 7, 2024 (CN) 202410178987.X

(51) Int. Cl. H01M 50/119; H01M 50/103; H01M 50/107

(52) U.S. Cl. CPC H01M 50/119; H01M 50/103; H01M 50/107

(57) ABSTRACT

A method for manufacturing a tubular enclosure for a battery cell includes bending a steel sheet into a tubular body. The steel comprises iron; carbon in a range from 0.01 wt % to 0.1 wt %; niobium in a range from 0.01 to 0.2 wt %; and at least one of a first group and a second group. The first group comprises copper in a range from 0.01 to 2.0 wt %; nickel in a range from 1 to 6.0 wt %; aluminum in a range from 0.1 to 1.0 wt %; manganese in a range from 0.1 to 1.0 wt %; and molybdenum in a range from 0.1 to 2.0 wt %. The second group comprises titanium in a range from 0.1 to 1.5 wt %; and silicon in a range from 0.1 to 1.5 wt %. Edges of the tubular body are welded and the tubular body is age hardened.

### CROSS-REFERENCE TO RELATED APPLICATIONS

This application claims the benefit of Chinese Patent Application No. 202410178987.X, filed on Feb. 7, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to enclosures for battery cells including nanoprecipitation strengthened steel.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include one or more cathode electrodes, anode electrodes, and separators arranged in a battery cell enclosure. The cathode electrodes include a cathode active material layer arranged on a cathode current collector. The anode electrodes include an anode active material layer arranged on an anode current collector.

### SUMMARY

A method for manufacturing a tubular enclosure for a battery cell including bending a sheet made of steel into a tubular body having one of a cylindrical shape and a prismatic shape. The steel comprises iron (Fe); carbon in a range from 0.01 wt % to 0.1 wt %; niobium in a range from 0.01 to 0.2 wt %; and at least one of a first group and a second group. The first group comprises copper in a range from 0.01 to 2.0 wt %; nickel in a range from 1 to 6.0 wt %; aluminum in a range from 0.1 to 1.0 wt %; manganese in a range from 0.1 to 1.0 wt %; and molybdenum in a range from 0.1 to 2.0 wt %. The second group comprises titanium in a range from 0.1 to 1.5 wt %; and silicon in a range from 0.1 to 1.5 wt %. The method includes welding opposite edges of the tubular body to form a weld seam and age hardening the tubular body after welding.

In other features, the method includes attaching a bottom portion onto one end of the tubular enclosure. The steel comprises the first group and the second group. A weight ratio of Ni/Cu is greater than 0.3. A weight ratio of Ni/Al is in a range from 2 and 5. A weight ratio of Ni/Mn is in a range from 1 to 3. A weight ratio of Si/Ti is in a range from 1.5 and 3.

In other features, the steel comprises the second group. A weight ratio of Si/Ti is in a range from 1 to 3.

In other features, the steel comprises the first group. A weight ratio of Ni/Cu is greater than 0.3. A weight ratio of Ni/Al is in a range from 2 to 5. A weight ratio of Ni/Mn is in a range from 1 to 3.

In other features, the tubular body is age-hardened by heating to a temperature in a range from 400° C. to 600° C. for a predetermined soak period. A precipitation fraction of the steel is in a range from 2 vol % to 20 vol %. A precipitation particle size is in a range from 1 nm to 100 nm.

In other features, the steel includes nanoprecipitates of Cu, Ni/Al/Ti intermetallics, and Fe2SiTi intermetallics. A thermal conductivity of the steel is greater than 40 W/mK. The steel has a yield strength greater than 700 MPa at room temperature, and the steel maintains a yield strength greater than 200 MPa at 600° C.

A tubular enclosure for a battery cell includes a tubular body made using a sheet of steel and including a weld seam. The steel comprises iron (Fe); carbon in a range from 0.01 wt % to 0.1 wt %; niobium in a range from 0.01 to 0.2 wt %; and at least one of a first group and a second group. The first group comprises copper in a range from 0.01 wt % to 2.0 wt %; nickel in a range from 1 wt % to 6.0 wt %; aluminum in a range from 0.1 wt % to 1.0 wt %; manganese in a range from 0.1 wt % to 1.0 wt %; and molybdenum in a range from 0.1 wt % to 2.0 wt %. The second group comprises titanium in a range from 0.1 wt % to 1.5 wt %; and silicon in a range from 0.1 wt % to 1.5 wt %. A bottom portion attached to one end of the tubular body.

In other features, the tubular body is age hardened for a predetermined soak period.

In other features, the steel comprises the first group and the second group. A weight ratio of Ni/Cu is greater than 0.3. A weight ratio of Ni/Al is in a range from 2 and 5. A weight ratio of Ni/Mn is in a range from 1 to 3. A weight ratio of Si/Ti is in a range from 1.5 and 3.

In other features, the steel comprises the second group. A weight ratio of Si/Ti is in a range from 1 to 3.

In other features, the steel comprises the first group. A weight ratio of Ni/Cu is greater than 0.3. A weight ratio of Ni/Al is in a range from 2 to 5. A weight ratio of Ni/Mn is in a range from 1 to 3.

In other features, the tubular body is age hardened by heating to a temperature in a range from 400° C. to 600° C. for a predetermined soak period. A precipitation fraction of the steel is in a range from 2 vol % to 20 vol %. A precipitation particle size is in a range from 1 nm to 100 nm.

In other features, the steel includes nanoprecipitates of Cu, Ni/Al/Ti intermetallics, and Fe2SiTi intermetallics. A thermal conductivity of the steel is greater than 40 W/mK. The steel has a yield strength greater than 700 MPa at room temperature. The steel maintains a strength greater than 200 MPa at 600° C.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including a battery cell stack including anode electrodes, cathode electrodes, and separators arranged in an enclosure made of nanoprecipitation strengthened steel according to the present disclosure;

FIGS. 2A and 2B are perspective views of examples of prismatic battery cell enclosures made of nanoprecipitation strengthened steel according to the present disclosure; and

FIG. 3 is a side cross section of an example of a cylindrical battery cell enclosure made of nanoprecipitation strengthened steel according to the present disclosure;

FIG. 4 is a side view of an example of a tube during induction welding according to the present disclosure;

FIG. 5 is a flowchart of an example of a method for manufacturing an enclosure for a battery cell according to the present disclosure;

FIG. 6 is a transmission electron microscope image of an example of the tubular enclosure after age hardening;

FIGS. 7A and 7B are simulations indicating estimated volume fractions of phases as a function of temperature for an example of the enclosure according to the present disclosure; and

FIGS. 8A and 8B illustrate a comparison in weld quality after welding and after age hardening, respectively according to the present disclosure.

In the drawings, reference numbers may be reused to identify similar and/or identical elements.

### DETAILED DESCRIPTION

While battery enclosures according to the present disclosure are shown in the context of electric vehicles, the battery enclosures can be used in stationary applications and/or in other applications.

Battery cells include a stack of anode electrodes, cathode electrodes, and separators that are arranged in a battery cell stack. The battery cell stack is arranged in an enclosure. For cylindrical and prismatic battery cells, the enclosures are typically made of metallic materials such as steel or aluminum, respectively.

The melting temperature of steel (approx. 1500-1530 deg C) is about 2.5 times higher than the melting temperature of aluminum (approx. 600-600 deg C). Using steel to manufacture the enclosures helps to maintain the integrity of the enclosure during thermal runaway events when the temperature of the enclosure can reach high temperatures (600-800 C) which can cause the aluminum casing to melt completely.

Despite the increased strength of steel at room temperature compared to aluminum and its greater melting temperature than aluminum, sidewalls of the enclosures may still fail during thermal runaway. For example, sidewall failures may occur in battery cells with thin steel walls (e.g., 0.2 mm to 0.3 mm thickness). Sidewall failure can be mitigated by increasing the thickness of the steel walls of the enclosure. However, increasing the thickness of the steel walls reduces gravimetric energy density (Wh/kg) of the battery cells.

During thermal runaway, the internal temperature inside of the enclosure may rise above 1000° C. and the steel enclosure may be heated to a temperature in a range from 500° C. to 800° C. Mild steel softens above 500° C. and its tensile strength at around 800° C. is about 1/10^{th} of the room temperature strength. Therefore, the heating of the steel enclosure during thermal runaway is sufficient to soften the steel casing, which may trigger side wall rupture.

The enclosure may also fail in response to increased vent gas pressure in combination with the softening of the enclosure. For example, increased vent gas pressure may occur during thermal runaway when the safety vent malfunctions and is unable to release the vent gases that are generated.

The present disclosure relates to an enclosure for cylindrical and prismatic battery cells using a steel composition with high elevated-temperature strength due to nanoprecipitation strengthened of Cu, Ni/Al/Ti intermetallics, and/or Fe2SiTi intermetallics. The nanoprecipitates are resistant to coarsening and dissolve only at elevated temperatures above 750 to 800° C. The nanoprecipitates in the steel substrate cause the steel to soften more gradually as compared to mild steel alloys without the precipitates. Because the steel is designed with a lean alloy content, the steel has high thermal conductivity (e.g., above 40 W/mK which is similar to mild steel).

The manufacturing method according to the present disclosure uses age hardening to increase the yield strength of the steel. Age hardening relies on changes in solid solubility and diffusion kinetics (faster atom diffusion at higher temperatures) with temperature to produce nanoprecipitates of an impurity phase in the steel matrix. The impurity phase impedes the movement of dislocations or defects in the crystal lattice. Since dislocations are often the dominant carriers of plasticity, the impurity phase hardens the steel.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26. The A anode electrodes 40-1, 40-2, . . . , and 40-A include anode active material layers 42 arranged on one or both sides of the anode current collectors 46. In some examples, the A anode electrodes 40 and the C cathode electrodes 20 exchange lithium ions during charging/discharging.

In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process), although other manufacturing methods can be used. In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

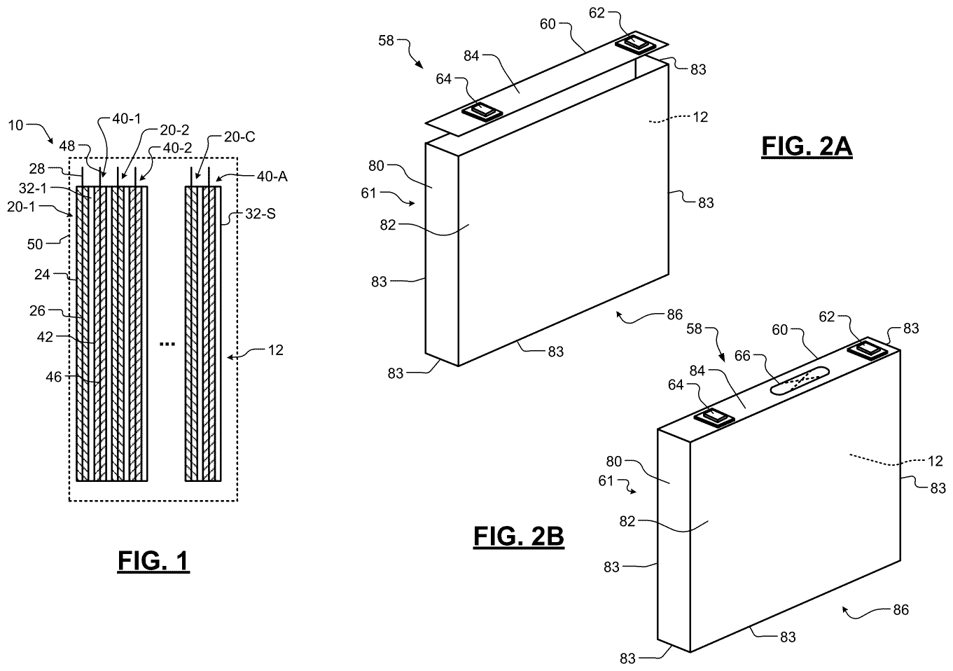

Referring now to FIGS. 2A and 2B, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 corresponding to narrow faces and sides 82 corresponding to wide faces. The enclosure body 61 defines an open-ended rectangular prism. In some examples, the enclosure 60 includes a lid portion 84 and a bottom portion 86. In other examples, the bottom portion 86 is attached after the enclosure body 61 is formed. Edges 83 are arranged between the sides 80 and 82, the sides 80 and 82 and a lid portion 84, the sides 80 and 82 and the bottom portion 86.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The battery cell stack 12 of the C cathode electrodes 20, the A anode electrodes 40, and the S separators 32 is arranged in the enclosure 60.

The external terminals 62 and 64 are connected to external tabs 28 and 48 of the C cathode electrodes 20 and the A anode electrodes 40, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

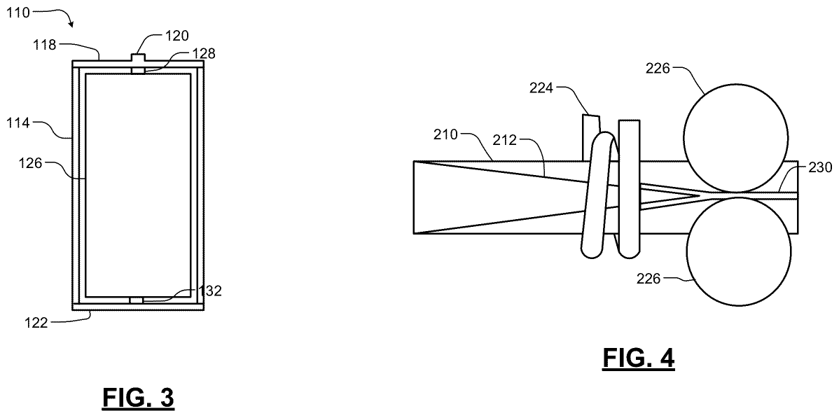

Referring now to FIG. 3, a cylindrical battery cell 110 includes a tubular enclosure 114, a lid portion 118 including a positive terminal 120, and a bottom portion 122. A battery cell stack 126 (e.g., a jellyroll) is arranged in the tubular enclosure 114. External tabs 128 and 132 connect cathode and anode electrodes to the positive terminal 120 and the negative terminal (e.g., on the bottom portion 122).

Referring now to FIG. 4, a flat sheet of steel having the desired composition is roll formed into a tube 210 and welded. Opposite sides of the tube 210 are rolled and welded using resistance welding, induction welding, friction stir welding, or other type of welding to close the open ends along the length of the sheet to form a hollow rectangular tube.

The tube 210 is shown during induction welding. The tube 210 can have an open-ended cylindrical or (rectangular) prismatic cross section. During welding of a seam, current flows through an inductive coil 224 that is wound around the tube 210 to generate a time-varying magnetic field that heats the tube 210. Weld rollers 226 press and weld opposite sides 212 of the tube 210 together to form a weld seam 230.

Mild steel typically includes carbon (up to 0.1 wt. %) manganese (e.g., 0.16 wt %), phosphorous (e.g., 0.008 wt %), chromium (e.g., 0.056 wt %), copper (e.g., 0.012 wt %), molybdenum (e.g., 0.002 wt %), vanadium (e.g., 0.003 wt %), titanium (e.g., 0.003 wt %), and cobalt (e.g., 0.006 wt %). While mild steel can be replaced by stainless steel to provide increased heat resistance, stainless steel has lower thermal conductivity.

In some examples, the tube 210 is formed using soft steel with lean alloying content. The steel is roll-formed and welded into a rectangular/cylindrical tube when it is soft prior to any age hardening treatment that creates the nano-precipitates. Once the tube is made, the steel tube will be age hardened to form the nano-precipitates in the steel matrix for both increased strength as well as for heat resistance. In some examples, the tube 210 is made of low alloy steel with increased heat resistance and lean alloying (for cost reduction, improved weldability, thermal conductivity, and formability).

Depending upon the design objectives, different steel compositions can be used. In some examples, the steel for the battery enclosure is optimized for thermal conductivity, cost, and high temperature strength and has a chemical composition including carbon in a range from 0.01 wt % to 0.1 wt %, niobium in a range from 0.01 wt % to 0.2 wt %, copper in a range from 0.1 wt % to 2.0 wt %, nickel in a range from 1.0 wt % to 6.0 wt %, aluminum in a range from 0.1 wt % to 1.0 wt %, manganese in a range from 0.1 wt % to 1.0 wt %, molybdenum in a range from 0.1 wt % to 2.5 wt %, titanium in a range from 0.1 wt % to 1.5 wt %, silicon in a range from 0.5 wt % to 3.0 wt %, and iron (Fe) (and other optional materials) making up the balance. In some examples, the weight ratio of Ni/Cu is greater than 0.3, the weight ratio (by weight) of Ni/Al is in a range from 2 and 5, the weight ratio of Ni/Mn is in a range from 1 to 3, and the weight ratio of Si/Ti is in a range from 1.5 and 3.

In other examples, the steel for the battery enclosure is optimized for cost and high temperature strength and has a chemical composition including carbon in a range from 0.01 wt % to 0.1 wt %, niobium in a range from 0.01 wt % to 0.2 wt %, titanium in a range from 0.1 wt % to 1.5 wt %, silicon in a range from 0.5 wt % to 3.0 wt %, and iron (Fe) (and other optional materials) making up the balance. In some examples, the weight ratio of Si/Ti is in a range from 1 to 3.

In other examples, the steel for the battery enclosure is optimized for thermal conductivity and has a chemical composition including carbon in a range from 0.01 wt % to 0.1 wt %, niobium in a range from 0.01 wt % to 0.2 wt %, copper in a range from 0.1 wt % to 2.0 wt %, nickel in a range from 1.0 wt % to 6.0 wt %, aluminum in a range from 0.1 wt % to 1.0 wt %, manganese in a range from 0.1 wt % to 1.0 wt %, molybdenum in a range from 0.1 wt % to 2.5 wt %, and iron (Fe) (and other optional materials) making up the balance. The ratio (by wt) of Ni/Al is in a range from 2 to 5 and a ratio of Ni/Mn is in a range from 1 to 3.

The carbon and niobium provide carbides for grain refinement and precipitate hardening. The copper, nickel, aluminum, manganese, molybdenum, and titanium support Cu— and Ni—Al—Ti co-precipitation. Mn and Mo control precipitate size and distribution of precipitates. The iron, titanium, and silicon form Fe2SiTi nanoprecipitates.

In some examples, a precipitation fraction is in a range from 2 vol % to 20 vol %. In some examples, a precipitation particle size is in a range from 1 nm to 100 nm. In some examples, the precipitation comprises Cu, Ni/Al/Ti intermetallics, and/or Fe2SiTi intermetallics. In some examples, the steel composition has high thermal conductivity (e.g., >40 W/mK) due to lean alloy chemistry (as compared to stainless steel). In some examples, the hardness difference between the seam weld and the bulk steel is less than 50 HV (Vickers Pyramid Number).

In some examples, the steel has a yield strength after age hardening that is greater than 700 MPa at room temperature and maintains a yield strength greater than 200 MPa at 600° C. In other words, the steel has about 4 times the strength of the steel used in the 4680 enclosure and 20 times the strength of conventional aluminum prismatic enclosures at 600° C.

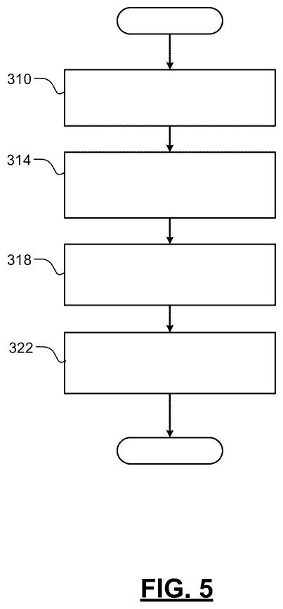

Referring now to FIG. 5, a method for manufacturing a tubular enclosure is shown. At 310, a un-aged nanoprecipitation steel sheet having the desired steel composition is roll-formed into a tube. The enclosure is formed in non-aged (soft) condition when the steel is formable and can be bent into an open-ended cylinder or rectangular prism with sharp corners and without cracking. At 314, opposite edges of tube are seam welded to form the open-ended tubular enclosure.

At 318, the tubular enclosure is age hardened. In some examples, the tubular enclosure is heated to a temperature in a range from 400° C. to 600° C. for a predetermined soak period. In some examples, the predetermined soak period is in the range from 6 minutes to 10 hours. At 322, a bottom portion is attached to one end of the tubular enclosure using brazing, crimping, or welding. Subsequently, the battery cell stack is arranged in the enclosure, terminals are connected, and the lid portion is attached to the opposite end of the tubular enclosure.

The age hardening of the steel enclosure improves the strength and corrosion resistance. In some examples, the steel is nickel plated and the corrosion performance improved due to diffusion annealing of the nickel coating. The improvement of corrosion resistance The steel composition of the enclosure balances strengthening and thermal conductivity by nanoprecipitation strengthened using a lean alloy chemistry described herein. The steel includes nanoprecipitation strengthened of Cu and Ni/Al/Ti intermetallics, and/or Fe2SiTi intermetallics to allow the enclosure to withstand increased thermal runaway temperatures in a range from 600° C. to 800° C.

The addition of silicon and titanium (in addition to nanoprecipitation strengthened elements) enables Fe—Si—Ti precipitation strengthening to partly replace Ni-based precipitation to reduce cost. The silicon and titanium delay austenitization transformation at high temperatures, which further increases high temperature strength.

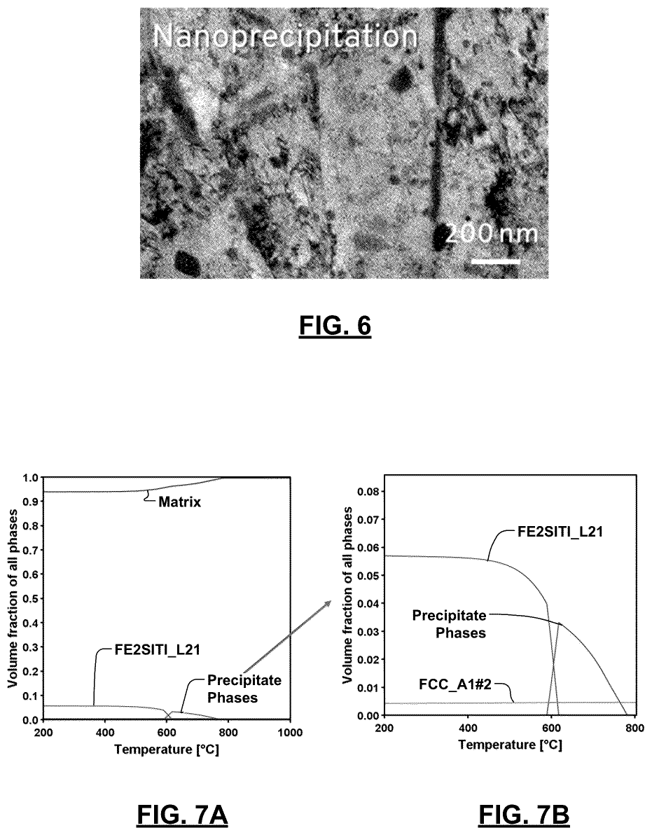

Referring now to FIG. 6, transmission electron microscope images of the tubular enclosure are shown. In this example, the steel composition includes carbon at 0.05 wt %, nickel at 5.5 wt %, copper at 1.2 wt %, aluminum at 1.2 wt %, and niobium at 0.015 wt %. The steel has ultimate tensile strength of around 1400 MPa and thermal conductivity of about 40 W/mK. The nanoprecipitates can be seen as dark spots in FIG. 6.

Referring now to FIGS. 7A and 7B, simulations (e.g., Thermo-Calc® simulations) show estimated (equilibrium) volume fractions of phases as a function of temperature for the enclosure. The simulations indicate that the precipitate phases remain until elevated temperatures of 800° C. (e.g., at equilibrium conditions). Due to the slow diffusion rate of alloy elements, the dissolution temperature could be even higher in service.

| Material | YS at RT | YS at 300° C. | YS at 600° C. |
|---|---|---|---|
| A3003-H14 | 150 | 60 | Nearly |
| | | | melted |
| CR4 steel | 150 | 120 | 100 |
| 4680 Steel | 150 | 80 | 60 |
| This disclosure | >700 | >400 | >200 |
| Example: | 1020 | 810 | 300 |
| 0.05 wt % C | | | |
| 5.5 wt % Ni | | | |
| 1.2 wt % Al | | | |
| 1.2 wt % Cu | | | |
| 0.015 wt % Nb | | | |

For the example above, as-aged hardness was 415 HV, 415 HV after 40 minutes at 500° C., 399 HV after 40 minutes at 550° C., and 409 HV after 40 minutes at 600° C.

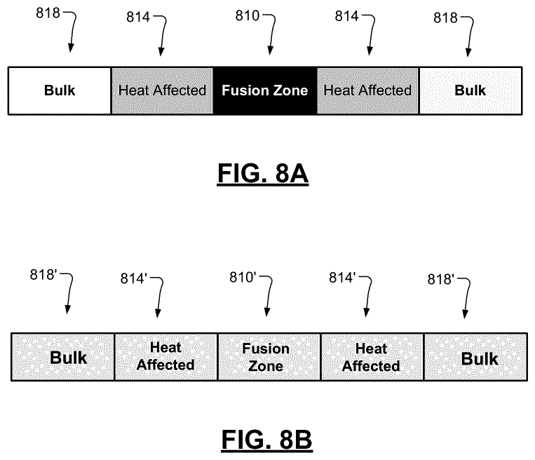

Referring now to FIGS. 8A and 8B, improvements in weld quality can be seen after age hardening treatment of the roll formed enclosure. In FIG. 8A, material in the middle of the weld is fusion hardened at 810. Adjacent areas to the weld are heat affected 814 (e.g., softened due to heat). The outer areas of the enclosure include bulk steel 818 that is not heat affected. In FIG. 8B, the various zones (810′, 814′, and 818′) of tubular enclosure are shown after age hardening and the hardness is approximately uniform.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing a tubular enclosure for a battery cell, comprising:
bending a sheet made of steel into a tubular body having one of a cylindrical shape and a prismatic shape,
wherein the steel comprises:
iron (Fe);
carbon in a range from 0.01 wt % to 0.1 wt %;
niobium in a range from 0.01 to 0.2 wt %; and
at least one of a first group and a second group,
wherein the first group comprises:
copper in a range from 0.01 to 2.0 wt %;
nickel in a range from 1 to 6.0 wt %;
aluminum in a range from 0.1 to 1.0 wt %;
manganese in a range from 0.1 to 1.0 wt %; and
molybdenum in a range from 0.1 to 2.0 wt %;
wherein the second group comprises:
titanium in a range from 0.1 to 1.5 wt %; and
silicon in a range from 0.1 to 1.5 wt %;
welding opposite edges of the tubular body to form a weld seam; and
age hardening the tubular body after welding.

2. The method of claim 1, further comprising attaching a bottom portion onto one end of the tubular enclosure.

3. The method of claim 1, wherein:
the steel comprises the first group and the second group,
a weight ratio of Ni/Cu is greater than 0.3,
a weight ratio of Ni/Al is in a range from 2 and 5,
a weight ratio of Ni/Mn is in a range from 1 to 3, and
a weight ratio of Si/Ti is in a range from 1.5 and 3.

4. The method of claim 1, wherein:
the steel comprises the second group, and
a weight ratio of Si/Ti is in a range from 1 to 3.

5. The method of claim 1, wherein:
the steel comprises the first group,
a weight ratio of Ni/Cu is greater than 0.3,
a weight ratio of Ni/Al is in a range from 2 to 5, and
a weight ratio of Ni/Mn is in a range from 1 to 3.

6. The method of claim 1, wherein the tubular body is age-hardened by heating to a temperature in a range from 400° C. to 600° C. for a predetermined soak period.

7. The method of claim 1, wherein:
a precipitation fraction of the steel is in a range from 2 vol % to 20 vol %, and
a precipitation particle size is in a range from 1 nm to 100 nm.

8. The method of claim 1, wherein the steel includes nanoprecipitates of Cu, Ni/Al/Ti intermetallics, and Fe₂SiTi intermetallics.

9. The method of claim 1, wherein a thermal conductivity of the steel is greater than 40 W/mK.

10. The method of claim 1, wherein:
the steel has a yield strength greater than 700 MPa at room temperature, and
the steel maintains a yield strength greater than 200 MPa at 600° C.

11. A tubular enclosure for a battery cell, comprising:
a tubular body made using a sheet of steel, having one of a cylindrical shape and a prismatic shape, and including a weld seam,
wherein the steel comprises:
iron (Fe);
carbon in a range from 0.01 wt % to 0.1 wt %;
niobium in a range from 0.01 to 0.2 wt %; and
at least one of a first group and a second group,
wherein the first group comprises:
copper in a range from 0.01 wt % to 2.0 wt %;
nickel in a range from 1 wt % to 6.0 wt %;
aluminum in a range from 0.1 wt % to 1.0 wt %;
manganese in a range from 0.1 wt % to 1.0 wt %; and
molybdenum in a range from 0.1 wt % to 2.0 wt %;
wherein the second group comprises:
titanium in a range from 0.1 wt % to 1.5 wt %; and
silicon in a range from 0.1 wt % to 1.5 wt %; and
a bottom portion attached to one end of the tubular body.

12. The tubular enclosure of claim 11, wherein the tubular body is age hardened for a predetermined soak period.

13. The tubular enclosure of claim 11, wherein:
the steel comprises the first group and the second group,
a weight ratio of Ni/Cu is greater than 0.3,
a weight ratio of Ni/Al is in a range from 2 and 5,
a weight ratio of Ni/Mn is in a range from 1 to 3, and
a weight ratio of Si/Ti is in a range from 1.5 and 3.

14. The tubular enclosure of claim 11, wherein:
the steel comprises the second group, and
a weight ratio of Si/Ti is in a range from 1 to 3.

15. The tubular enclosure of claim 11, wherein:
the steel comprises the first group,
a weight ratio of Ni/Cu is greater than 0.3,
a weight ratio of Ni/Al is in a range from 2 to 5, and
a weight ratio of Ni/Mn is in a range from 1 to 3.

16. The tubular enclosure of claim 11, wherein the tubular body is age hardened by heating to a temperature in a range from 400° C. to 600° C. for a predetermined soak period.

17. The tubular enclosure of claim 11, wherein:
a precipitation fraction of the steel is in a range from 2 vol % to 20 vol %, and
a precipitation particle size is in a range from 1 nm to 100 nm.

18. The tubular enclosure of claim 11, wherein the steel includes nanoprecipitates of Cu, Ni/Al/Ti intermetallics, and Fe₂SiTi intermetallics.

19. The tubular enclosure of claim 11, wherein a thermal conductivity of the steel is greater than 40 W/mK.

20. The tubular enclosure of claim 11, wherein:
the steel has a yield strength greater than 700 MPa at room temperature, and
the steel maintains a strength greater than 200 MPa at 600° C.
